(19) United States
(12) Patent Application Publication
(10) Pub. No.: US 2015/0016037 A1
(43) Pub. Date: Jan. 15, 2015

(54) INFORMATION TERMINAL DEVICE

(71) Applicant: FUNAI ELECTRIC CO., LTD., Osaka (JP)

(72) Inventors: Kazutoshi TAKEMI, Osaka (JP); Mitsuyasu ASADA, Osaka (JP)

(21) Appl. No.: 14/322,110

(22) Filed: Jul. 2, 2014

(30) Foreign Application Priority Data
Jul. 9, 2013 (JP) 2013-143927

(51) Int. Cl. G06F 1/16; H02J 7/00; H02J 7/02

(52) U.S. Cl. CPC G06F 1/1632; H02J 7/025; H02J 7/0042
USPC 361/679.09; 361/679.26

(57) ABSTRACT

An information terminal device which is portable and capable of charging a charge target device includes: a first body part including a display panel and a case which covers the display panel; and a power transmission coil provided at a position on a back surface of the case opposite to the display panel, for supplying power to be charged in the charge target device in a non-contact manner.

### CROSS REFERENCE TO RELATED APPLICATION

The present application is based on and claims priority of Japanese Patent Application No. 2013-143927 filed on Jul. 9, 2013. The entire disclosure of the above-identified application, including the specification, drawings and claims is incorporated herein by reference in its entirety.

### FIELD

The present invention relates to information terminal devices capable of charging a charge target device such as a mobile terminal.

### BACKGROUND

Conventionally, a non-contact charging method has been an easy-to-use method for mobile terminals such as smart phones (see Patent Literature). A mobile terminal which supports non-contact charging can be easily charged only by being placed at a predetermined part of an exclusive non-contact charger.

### CITATION LIST

### Patent Literature

### [PTL]

Japanese Unexamined Patent Application Publication No. 2013-90557

### SUMMARY

### Technical Problem

In general, mobile terminals such as smart phones are carried around and used away from home, and the batteries thereof often need to be charged away from home. In order to charge a discharged battery of a mobile terminal by non-contact charging, a non-contact charger needs to be carried around. In short, a device only for charging use needs to be carried around.

On the other hand, if a mobile information terminal device such as a lap-top personal computer (PC) is carried around, it is possible to charge a mobile terminal by connecting it to the lap-top PC through, for example, a universal serial bus (USB) cable. However, it is bothersome to connect the information terminal device and the mobile terminal through the cable.

The present invention was made in view of such circumstances, with an aim to provide an information terminal device capable of easily charging a charge target device in a non-contact manner away from home.

### Solution to Problem

In order to achieve the above aim, the information terminal device according to the present invention which is portable and capable of charging a charge target device includes: a first body part including a display panel and a case which covers the display panel; and a power transmission coil provided at a position on a back surface of the case opposite to the display panel, for supplying power to be charged in the charge target device in a non-contact manner.

The information terminal device includes the case which covers the back surface of the display panel and includes, on the back surface of the case, the power transmission coil for supplying power to the charge target device in a non-contact manner. Thus, it is possible to charge the charge target device using the non-contact charging method only by placing the charge target device on the back surface of the information terminal device. In other words, with the mobile information terminal device which is easy to carry around, it is possible to easily charge the charge target device by non-contact charging away from home.

In addition, for example, the information terminal device may further include a holding part for holding the charge target device at a position in the case, the position corresponding to the power transmission coil.

Since the holding part for holding the charge target device is provided in the case, the charge target device can be integrated with the information terminal device by the holding part. In this way, it is possible to hold the charge target device in the holding part even when the posture of the information terminal device changes while the information terminal device is being carried around and used, and thus to keep charging the charge target device.

In addition, for example, the holding part may be provided in the case, and include a recess part to which the charge target device is fit

Since the holding part is the recess part to which the charge target device is fit, the charge target device is fit in the recess part at least partly during the charging. For this reason, it is possible to prevent the charge target device from protruding unnecessarily in a state in which the charge target device is integrated into the information terminal device. Thus, it is possible to carry around the information terminal device in a compact form.

In addition, for example, the holding part may further include: a plate member which fits in the recess part; and connection parts which connect the plate member and the case such that the plate member is movable between a first position and a second position relative to the case, the plate member being at the first position relative to the case when the plate member is fit in the recess part, and at the second position apart from the case by a predetermined distance in a direction opposite to a recess direction of the recess part.

In this way, since the holding part includes the recess part, the plate member which fits in the recess part, and the connection parts which connect the plate member and the case, it is possible to keep flat the back surface of the information terminal device during non-charging time in which the charge target device is not charged. In addition, at the time of charging, it is possible to charge the charge target device only by disposing the charge target device in the space formed between the plate member and the recess part in a state where the plate member is moved to the second position. At this time, the charge target device is placed in the space enclosed by the plate member and the recess part, and thus it can be protected against shock from outside.

In addition, for example, the power transmission coil may be provided in the plate member.

In this way, since the power transmission coil is provided for the plate member, the charge target device can be charged only by being placed on the plate member of the case even when the plate member is located at the first position. In addition, the charge target device can be charged also when being housed in the space formed between the plate member and the recess part after the plate member is moved to the second position. In this way, it is possible to charge the charge target device in the two forms. Thus, the user can select one of the forms for charging as necessary.

In addition, for example, the power transmission coil may be provided at a bottom surface of the recess part.

In this way, since the power transmission coil is provided at the bottom surface of the recess part, it is only necessary that the power transmission coil is disposed at the side of the case. Thus, the power transmission coil can be mounted easily.

The information terminal device may further include: a second body part including a keyboard which receives an input from a user; a hinge part which rotatably connects the first body part and the second body part at side end portions thereof; and a latch part capable of selectively maintaining and releasing, at opposite side end portions thereof, a state in which the first body part and the second body part are closed via the hinge part, wherein the latch part may further be capable of maintaining a state in which the plate member is fit in the recess part, and release the state in which the plate member is fit in the recess part, in conjunction with the release of the state in which the first body part and the second body part are closed via the hinge part.

In this way, it is possible to maintain the fitting state of the plate member in the recess part of the case, in conjunction with the release of the latch part fixing the opposite side end portions of the first body part and the second body part. In this way, the latch part fixes the first body part and the second body part and also fixes the plate member and the recess part, which contributes reduction in the number of components.

The information terminal device may further include a second body part including a keyboard for receiving an input from a user; a hinge part which rotatably connects the first body part and the second body part at side end portions thereof; and a latch part capable of selectively maintaining and releasing, at opposite side end portions thereof, a state in which the first body part and the second body part are closed via the hinge part, wherein the latch part may further be capable of maintaining a state in which the charge target device is fit in the recess part, and release the state in which the charge target device is fit in the recess part, in conjunction with the release of the state in which the first body part and the second body part are closed via the hinge part.

In this way, it is possible to release the fitting state of the charge target device in the recess part of the case, in conjunction with the release of the latch part fixing the opposite side end portions of the first body part and the second body part. In this way, the latch part fixes the first body part and the second body part and also fixes the charge target device and the recess part, which contributes reduction in the number of components. In addition, since the latch part maintains the charge target device which is fit in the recess part of the case, it is possible to prevent the charge target device from detaching from the recess part during charging due to shock from outside.

### Advantageous Effects

The information terminal device according to the present invention is capable of easily charging a charge target device in a non-contact manner away from home.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is an external perspective view of an information terminal device when closed according to Embodiment 1 of the present invention.

FIG. 2 is an external perspective view of the information terminal device when opened with a tray for non-contact charging opened.

FIG. 3 is an enlarged view of an area A1 in FIG. 2.

FIG. 4 is an external perspective view of the information terminal device when a charge target device is mounted for charging in a holding part of the information terminal device in FIG. 2.

FIG. 5 is an external perspective view of an information terminal device when closed according to Embodiment 2 of the present invention.

FIG. 6 is a view for explaining a structure of a latch part in a perspective view of a case of a first body part and a second body part of the information terminal device in FIG. 5.

FIG. 7A is a view of a state in which the first body part and the second body part are locked by the latch part.

FIG. 7B is a view of a state in which the first body part and second body part locked by the latch part releases are unlocked.

FIG. 8 is a view of a relationship between a protrusion part and a hole part of the charge target device.

### DESCRIPTION OF EMBODIMENTS

Hereinafter, embodiments are described with reference to the drawings. Each of the exemplary embodiments described below shows a preferred specific example. The numerical values, shapes, materials, structural elements, the arrangement and connection of the structural elements, etc. shown in the following exemplary embodiments are mere examples, and therefore do not limit the present invention. Therefore, among the structural elements in the following exemplary embodiments, structural elements not recited in any one of the independent claims which define the most generic concept of the present invention are described as arbitrary structural elements.

### Embodiment 1

The structure of an information terminal device 1 is described.

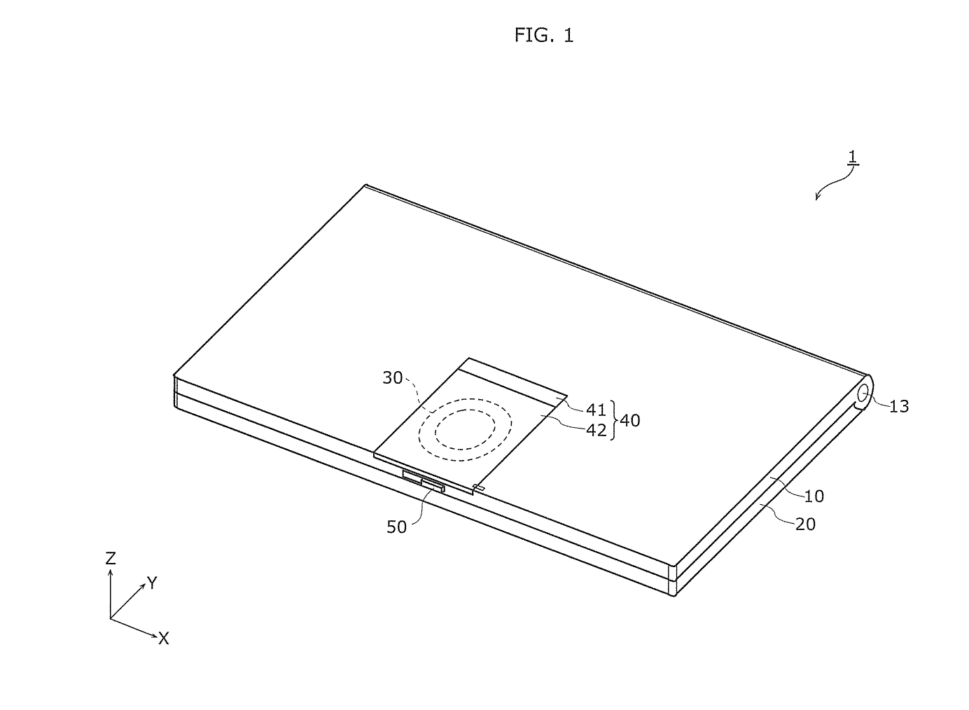

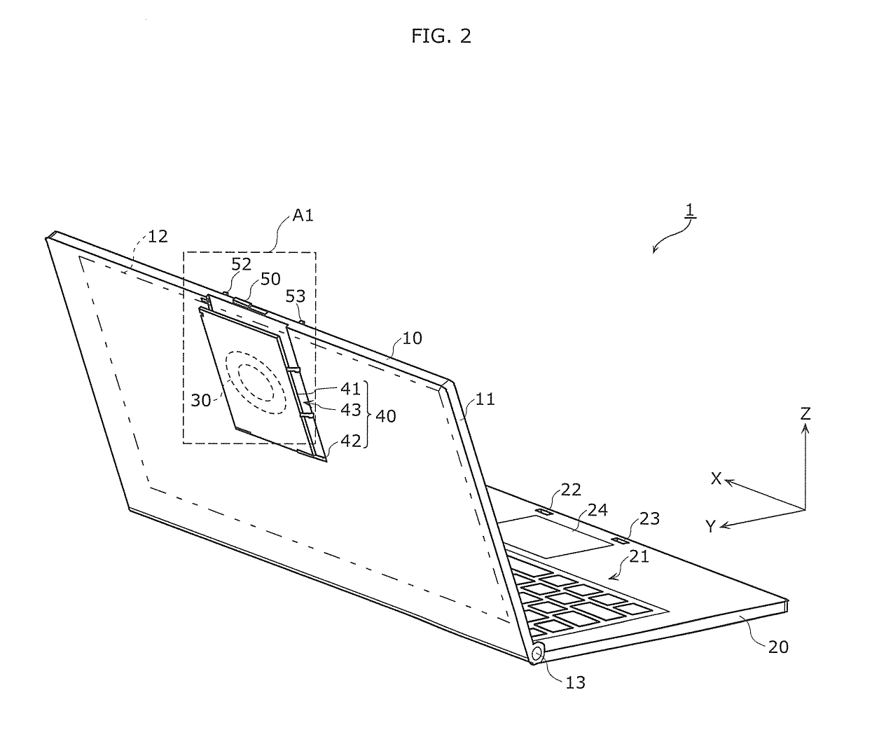

FIG. 1 is an external perspective view of the information terminal device when closed according to Embodiment 1 of the present invention. FIG. 2 is an external perspective view of the information terminal device when opened with a tray for non-contact charging opened.

It is to be noted that, in these drawings, a Z-axis direction is shown and described as a vertical direction, but the Z-axis direction is not limited to the vertical direction because the Z-axis direction may be another direction depending on a use style. This applies to the other drawings.

As shown in FIG. 1, the information terminal device 1 is a lap-top PC, and is a mobile device capable of supplying a charge target device 2 with power obtainable from an electric source plug (not shown) or an embedded battery. Here, examples of “the charge target device 2” include devices such as a mobile terminal represented by a smart phone, a mobile battery, an adapter capable of supplying power received by a non-contact charging method to a mobile terminal which does not support the non-contact charging method.

As shown in FIG. 1 and FIG. 2, the information terminal device 1 includes a first body part 10, a second body part 20, a power transmission coil 30, and a holding part 40.

The first body part 10 includes a display panel 12 and a case 11 which covers the display panel 12. The display panel 12 is a display part for displaying an image generated by the information terminal device 1, and is configured with, for example, a liquid crystal display, an organic EL display, or the like. The case 11 covers a back surface of the display panel 12, opposite to a display surface thereof. The case 11 includes a power transmission coil 30 at a position on the back surface of the display panel 12.

In addition, the holding part 40 is provided for holding the charge target device 2 at the position corresponding to the power transmission coil 30 on the case 11. The holding part 40 includes: a first plate member 41 and a second plate member 42; a recess part 43 formed in the case 11 in which the first plate member 41 and the second plate member 42 are fit; and a plurality of connection parts 44 which connect the first plate member 41 and the case 11. The first plate member 41 is provided with the power transmission coil 30. In addition, the second plate member 42 has, in a Y-axis direction in FIG. 1, ends connected rotatably to the case 11 and the first plate member 41. Together with the second plate member 42, the plurality of connection parts 44 connect the first plate member 41 and the case 11 such that the first plate member 41 is movable between a first position and a second position both of which are positions for the first plate member 41 relative to the case 11. Here, the first position is a position of the first plate member 41 relative to the case 11 when the first plate member 41 fits into the recess part 43 (in short, the state in FIG. 1). In addition, the second position is a position of the first plate member 41 relative to the case 11 when the first plate member 41 is apart from the case by a predetermined distance in the direction opposite to a recess direction of the recess part 43 (in short, the state in FIG. 2).

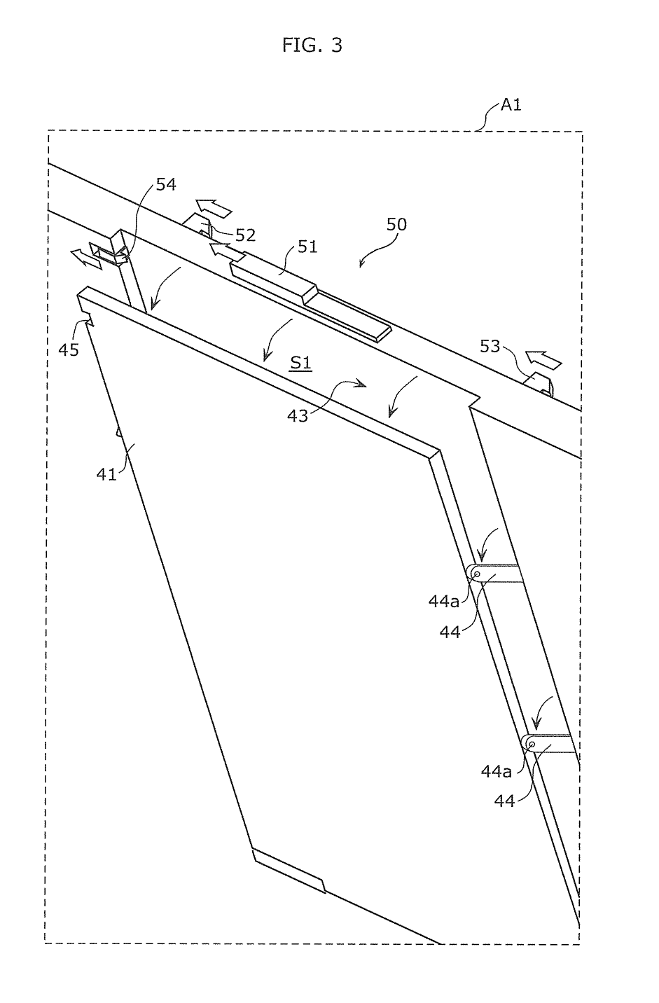

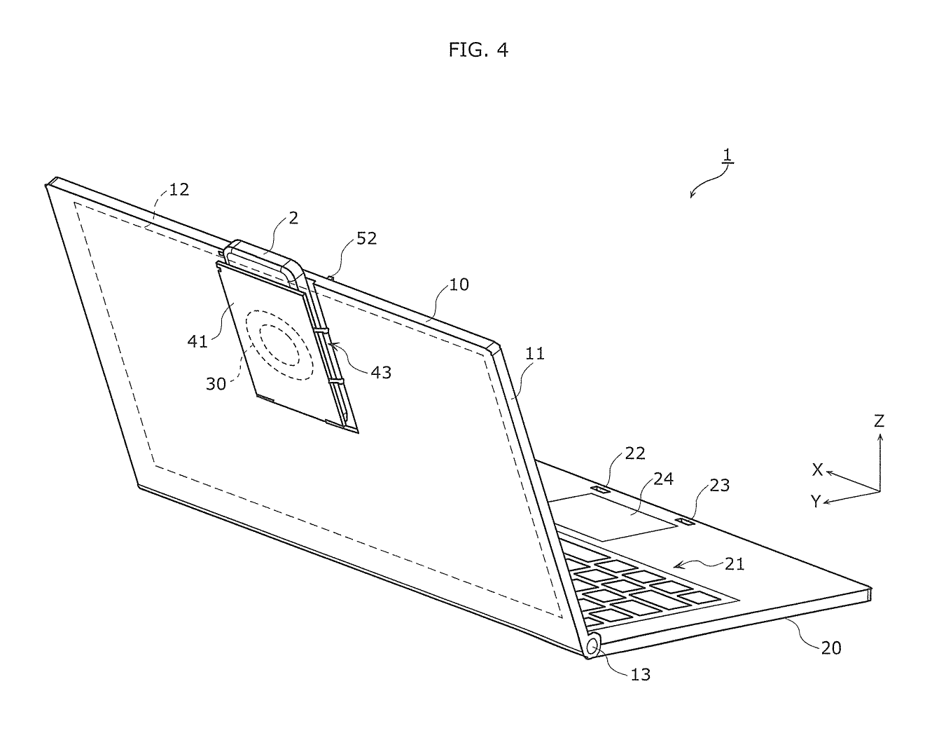

FIG. 3 is an enlarged view of an area A1 in FIG. 2. FIG. 4 is an external perspective view of the information terminal device when a charge target device is mounted for charging in the holding part of the information terminal device in FIG. 2.

As shown in FIG. 3, the plurality of connection parts 44 are, for example, rectangular plate members having an end in a longitudinal direction rotatably about a pin 44a as an axis so as to be connected to the first plate member 41 and having another end rotatably about a pin (not shown) as an axis so as to be connected to a side surface perpendicular to an X-axis direction of the recess part 43 formed in the case 11. In addition, pairs of the plurality of connection parts 44 are arranged apart on the respective sides in the X axis of the first plate member 41. In this way, the first plate member 41 can move horizontally in a direction away from the recess part 43, and can form space S1 defined by the first plate member 41 and a bottom surface of the recess part 43 which are parallel to each other.

The second body part 20 includes a keyboard 21 for receiving inputs from a user. In addition, the second body part 20 may include a touch pad 24 for receiving inputs from the user.

The first body part 10 and the second body part 20 are connected via a hinge part 13. In other words, the hinge part 13 connects the first body part 10 and the second body part 20 rotatably at the end portions thereof in a Y-axis plus direction in FIG. 1. It is to be noted that the hinge part 13 may connect the first body part 10 and the second body part 20 such that they can open up to an angle of 180 degrees, or an angle of 360 degrees. In other words, any angles are possible for angles at which the first body part 10 and the second body part 20 can open about the hinge part 13.

Next, the first body part 10 and the second body part 20 include a latch part 50 and opening parts 22 and 23. With the latch part 50, it is possible to maintain a state in which the first body part 10 and the second body part 20 is closed with an angle of 0 degree, and release the state. More specifically, the first body part 10 includes the latch part 50 for latching the opening parts 22 and 23 formed in the second body part 20. As shown in FIG. 2 and FIG. 3, the latch part 50 includes a tab 51, a first hook 52, a second hook 53, and a third hook 54. In the latch part 50, the tab 51 is a part on which a user adds a force in an X-axis plus direction. The first hook 52 and the second hook 53 are members for hooking the opening parts 22 and 23 formed in the second body part 20, and mechanisms for holding the state in which the first body part 10 and the second body part 20 are closed. The third hook 54 is a mechanism which fits in a hole part 45 formed in a first plate member 41 of the holding part 40, and thereby maintains the state in which the first plate member 41 is closed. In the latch part 50, in a state in which a force is added by a spring in an X-axis minus direction and the tab 51 is slid by the user in the X-axis plus direction, the first hook 52, the second hook 53, and the third hook 54 are also slid in conjunction with the slide of the tab 51 in the same direction (see white arrows in FIG. 3). In other words, in a state in which the first body part 10 and the second body part 20 are closed or in a state in which the first plate member 41 fits in the recess part 43, the latch part 50 receives a force in the X-axis minus direction by the spring if the tab 51 is not slid. This holds either the state in which the first body part 10 and the second body part 20 are closed or in the state in which the first plate member 41 is fit in the recess part 43. When the user slides the tab 51 in the X-axis plus direction, the two states are released to release the latch between the first body part 10 and the second body part 20 and the latch between the first plate member 41 and the recess part 43. In other words, the latch part 50 can further maintain the state in which the first plate member 41 is fit in the recess part 43. Together with the hinge part 13 releasing the state in which the first body part 10 and the second body part 20 are closed, the latch part 50 releases the state in which the first plate member 41 is fit in the recess part.

In this way, in the closed state in which the third hook 54 of the latch part 50 latches the recess part 43, it is possible to move the first plate member 41 from a first position to a second position by sliding the tab 51 of the latch part 50. Next, as shown in FIG. 4, it is possible to easily charge the charge target device 2 using the information terminal device 1, by inserting the charge target device 2 in space S1 formed by moving the first plate member 41 to the second position.

### (Features)

(1)

The information terminal device 1 according to this embodiment includes the case which covers the back surface of the display panel 12 and, on the case, the power transmission coil 30 for supplying power to be charged in the charge target device 2 in a non-contact manner. Thus, it is possible to charge the charge target device 2 using the non-contact charging method only by placing the charge target device 2 on the back surface of the information terminal device 1. In other words, with the mobile information terminal device 1 which is easy to carry around, it is possible to easily charge the charge target device by non-contact charging away from home.

(2)

In addition, with the information terminal device 1 according to this embodiment, the holding part 40 includes the recess part 43, the first plate member 41 which fits in the recess part 43, and the connection parts 44 which connect the first plate member 41 to the recess part 43 of the case 11. Thus, the back surface of the information terminal device 1 is flat during non-charging time in which the charge target device 2 is not charged. In addition, at the time of charging the charge target device 2, it is possible to charge the charge target device 2 only by placing the charge target device 2 in the space S1 formed between the first plate member 41 and the recess part 43 in a sate in which the first plate member 41 is moved to the second position. At this time, the charge target device 2 is placed in the space S1 enclosed by the first plate member 41 and the recess part 43 of the case 11. Thus, it is possible to protect the charge target device 2 from shock from outside.

In addition, with the information terminal device 1 according to this embodiment, since the power transmission coil 30 is provided in the first plate member 41, it is possible to charge the charge target device 2 by placing the charge target device 2 on the first plate member 41 of the case 11 in the state in which the first plate member 41 is positioned at the first place. In other words, it is possible to charge the charge target device 2 by placing the charge target device 2 on the first plate member 41 in the state, shown in FIG. 1, in which the first body part 10 and the second body part 20 are closed. In addition, it is possible to charge the charge target device 2 by moving the first plate member 41 to the second position and housing the charge target device 2 in the space S1 formed between the first plate member 41 and the recess part 43. In this way, it is possible to charge the charge target device 2 in the two forms, and to select one of the forms for charging by the information terminal device 1 as necessary.

In addition, with the information terminal device 1 according to this embodiment, it is possible to release the state in which the first plate member 41 fits into the recess part 43 of the case 11, in conjunction with the release of the latch part 50 which fixes the first body part 10 and the second body part 20 at their end portions in a Y-axis plus direction in FIG. 1. In this way, the latch part 50 fixes the first body part 10 and the second body part 20 and also fixes the first plate member 41 and the recess part 43, which contributes reduction in the number of components.

### Variation

The information terminal device 1 according to the above-described embodiment includes the power transmission coil 30 on the first plate member 41, but the present invention is not limited thereto. For example, a coil may be provided in a recess part 43, or power transmission coils 30 may be provided in both of a first plate member 41 and a recess part 43. When the power transmission coils 30 are provided in both of the first plate member 41 and the recess part 43, it is also good to identify one of the power transmission coils 30 which is closer to a power reception coil of the charge target device 2 from among a first power transmission coil provided in the first plate member 41 and a second power transmission coil provided in the recess part 43, and to supply power to be charged in the charge target device 2 only to the identified coil. In other words, the information terminal device 1 may be configured to identify the coil having a higher power supply efficiency among the first power transmission coil and the second power transmission coil, and to supply power to be charged in the charge target device 2 only to the identified coil. By selecting the coil having the higher power supply efficiency and supplying the power to the selected coil in this way, it is possible to charge the charge target device 2 with the power without reducing the power supply efficiency irrespective of whether the user adjusts the orientation of the charge target device when inserting the charge target device 2 into the space formed by moving the first plate member to the second position. For this reason, it is possible to efficiently charge the charge target device 2 with the power.

### Embodiment 2

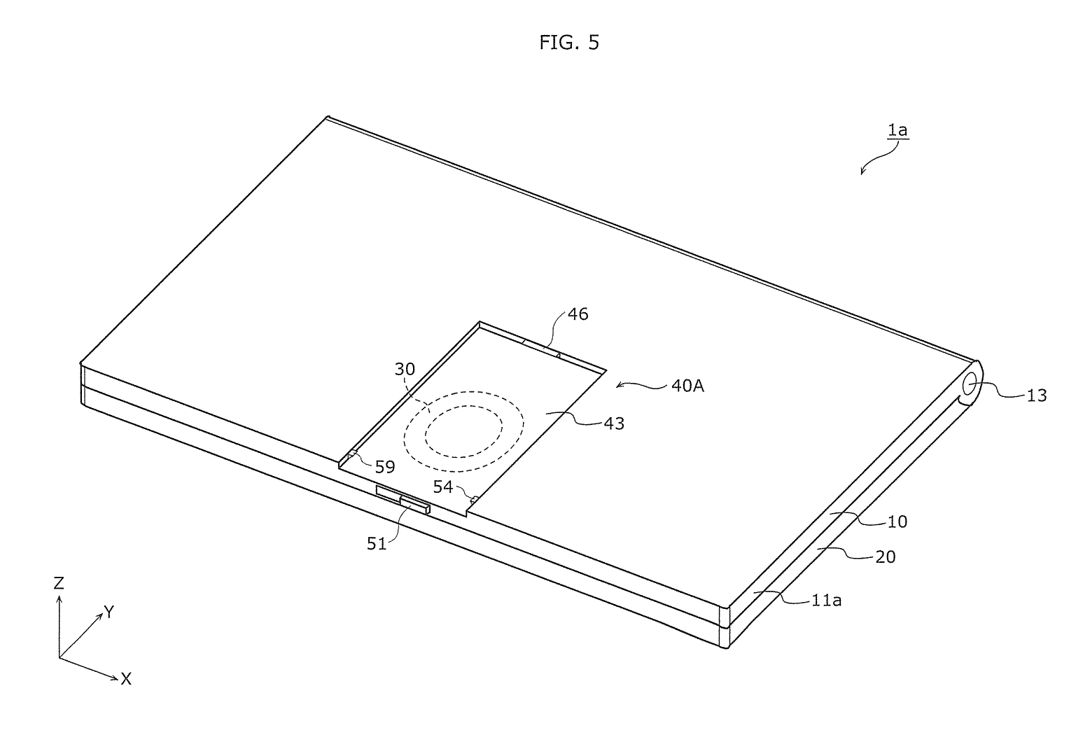

FIG. 5 is an external perspective view of the information terminal device when closed according to Embodiment 2 of the present invention.

As shown in FIG. 5, an information terminal device la according to Embodiment 2 does not include the first plate member 41, the second plate member 42, and the connection parts 44 provided in the information terminal device 1 according to Embodiment 1, and includes only a recess part 43 in a case 11a. In addition, the information terminal device la includes a holding part 40A including a protrusion part 46 provided at a side surface in a Y-axis plus direction of the recess part 43, a third hook 54 of a latch part 50A, and a fourth hook 59, in addition to the recess part 43. In this way, differently from the information terminal device 1 according to Embodiment 1, the information terminal device la according to Embodiment 2 has a structure in which the third hook 54 and the fourth hook 59 of the latch part 50A also serve as parts of the holding part 40A.

The other parts of the information terminal device 1a according to Embodiment 2 are the same as those of the information terminal device 1 according to Embodiment 1. The same parts are assigned with the same numerical references as assigned to the counterparts in the information terminal device 1, and the same descriptions are not repeated.

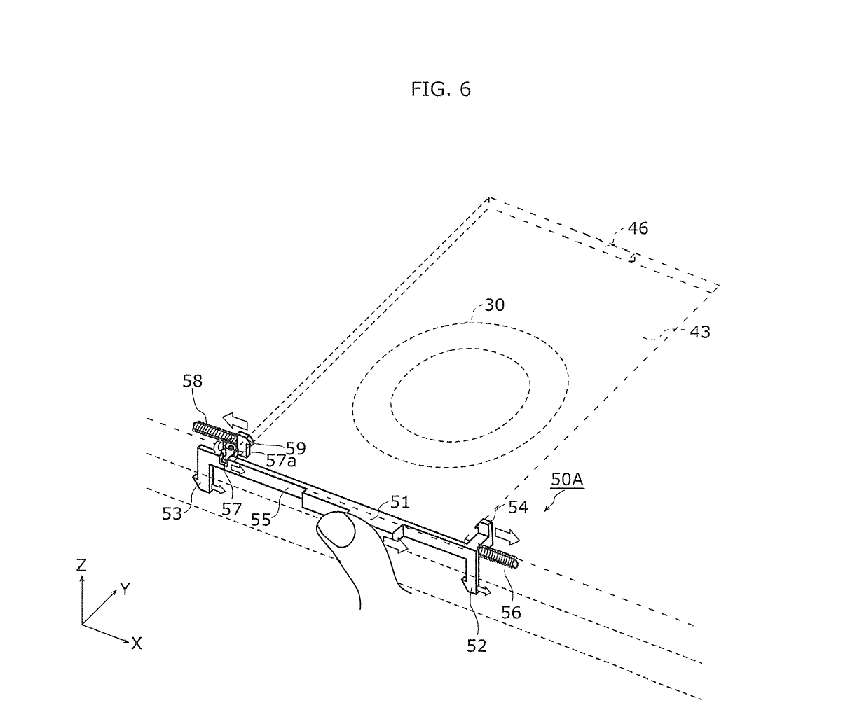

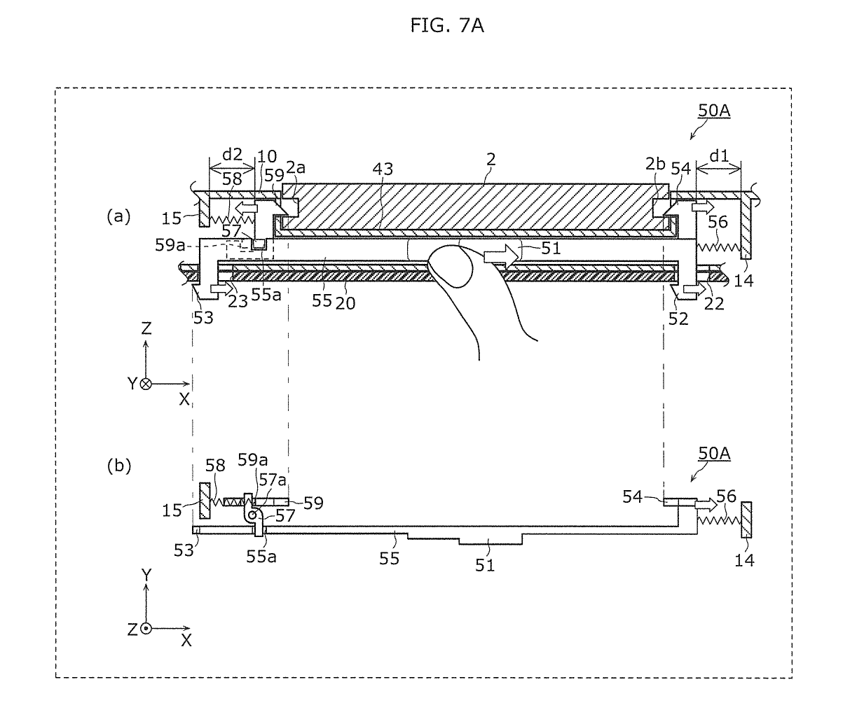

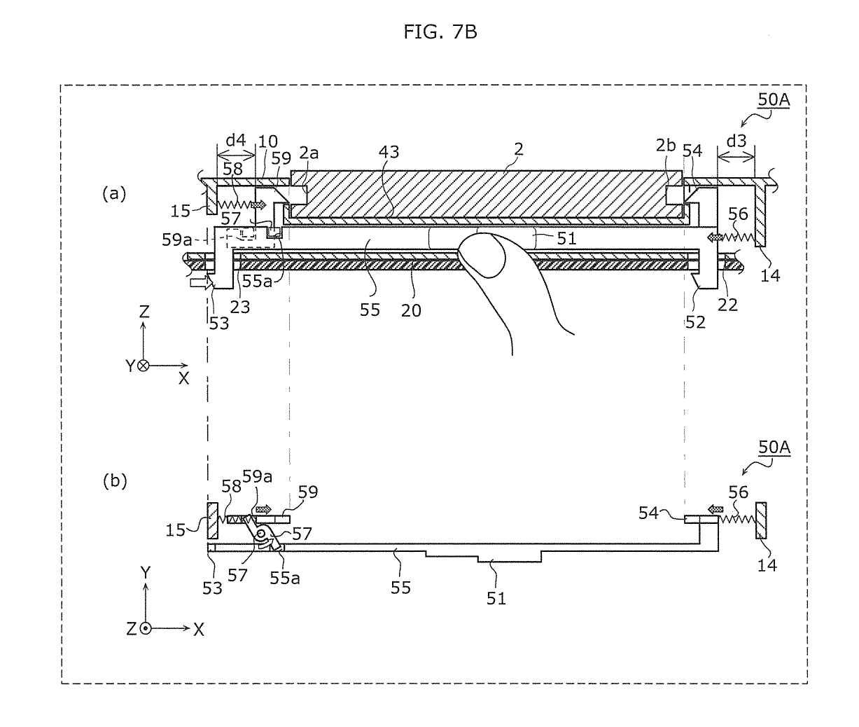

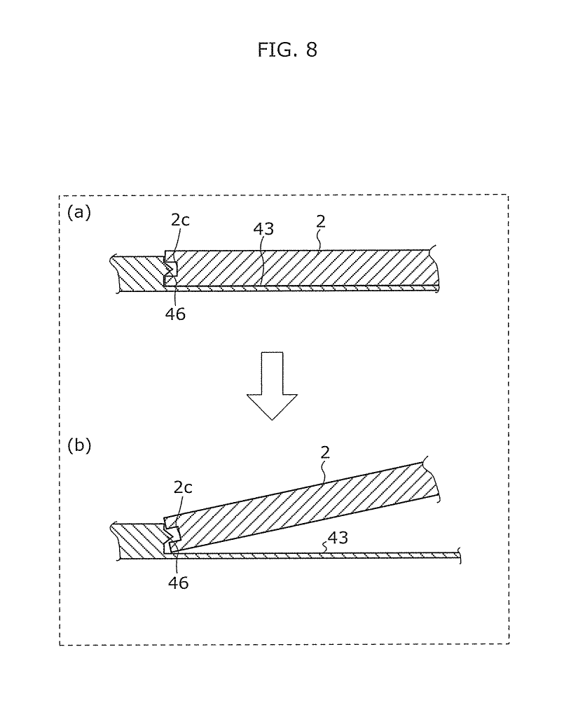

FIG. 6 is a view for explaining a structure of the latch part in a perspective view of the case of the first body part and the second body part of the information terminal device in FIG. 5. FIG. 7A is a view of a state in which the first body part and the second body part are locked by the latch part. FIG. 7B is a view of a state in which the first body part and second body part locked by the latch part are unlocked. More specifically, each of (a) in FIG. 7A and (a) in FIG. 7B is a cross-sectional view when seen in the Y-axis direction of the first body part and the second body part in the hook of the latch part in a corresponding one of the states in FIG. 7A and FIG. 7B. In addition, each of (b) in FIG. 7A and (b) in FIG. 7B is a view of the latch part when seen in a Z-axis direction in a corresponding one of the states in FIG. 7A and FIG. 7B. FIG. 8 is a view of a relationship between a protrusion part and a hole part of a charge target device. More specifically, (a) in FIG. 8 is a view of a state in which the charge target device is attached to the protrusion part, and (b) in FIG. 8 is a view showing a state in which the charge target device is detached from the protrusion part.

As shown in FIGS. 6, 7A, and 7B, the latch part 50A includes a tab 51, a first hook 52, a second hook 53, a third hook 54, a fourth hook 59, a slide part 55, a rotation part 57, a first spring 56, and a second spring 58.

The tab 51, the first hook 52, the second hook 53, and the third hook 54 are members formed on the slide part 55 having a long plate shape that extends in the X-axis direction. The tab 51 is a member which protrudes from a central point of the slide part 55 in the X-axis direction in the Y-axis minus direction. As shown in FIG. 6, the tab 51 allows a user to easily touch and slide with a finger in the X-axis plus direction.

The first hook 52 and the second hook 53 protrude from the both ends in the X-axis direction of the slide part 55 in the Z-axis minus direction, and have hook-shaped end portions in the X-axis minus direction at the end portions in the Z-axis minus direction. In other words, the first hook 52 and the second hook 53 are slid in the X-axis plus direction, and, as shown in (a) of FIG. 7B, are moved to the positions at which they are included in opening parts 22 and 23 formed in the second body part 20. For this reason, the first hook 52 and the second hook 53 are detached from the first body part 10 and the second body part 20.

Here, hole parts 2a and 2b are formed at points on side surfaces of the charge target device 2 in the X-axis direction, so that the third hook 54 and the fourth hook 59 of the latch part 50A corresponding to the points which are fit in the hold parts 2a and 2b when the charge target device 2 is fit into the recess part 43. In addition, the charge target device 2 includes a hole part 2c which is fit with the protrusion part 46 formed in the recess part 43 when the charge target device 2 is fit into the recess part 43 (see FIG. 8). In other words, when the hole parts 2a and 2b of the charge target device 2 is fit with the third hook 54 and the fourth hook 59 when the hole part 2c of the charge target device 2 is fit with the protrusion part 46, the charge target device 2 is fit in the recess part 43, supported by the third hook 54, the fourth hook 59, and the protrusion part 46.

The third hook 54 is positioned at an end portion of the slide part 55 in the X-axis direction, is formed to protrude from a point shifted from the second hook 53 in the Y-axis plus direction, toward the Z-axis plus direction, and has a hook-shaped end portion along the Z-axis plus direction, for hooking in the X-axis minus direction. The slide part 55 is slid in the X-axis plus direction, the third hook 54 moves outside of the hole part 2b in the charge target device 2. In addition, the third hook 54 has a hook-shaped end portion in the same direction as the hooking directions of the first hook 52 and the second hook 53. Thus, when the slide part 55 is slid, the first body part 10 and the second body part 20 fixed by the first hook 52 and the second hook 53 are released, and the charge target device 2 fixed in the hole part 2b by the third hook 54 is also released.

In addition, the slide part 55 includes a notch part 55a formed therein.

The rotation part 57 is rotatable about the rotation axis 57a, and has an end portion which is fit in the notch part 55a formed in the slide part 55, in the Y-axis minus direction of the rotation part 57. The rotation axis 57a is disposed along the Z-axis direction. In other words, the rotation part 57 rotates about the Z-axis direction, parallel to an X-Y plane. In addition, the rotation part 57 has an end portion which is fit in a notch part 59a formed in the fourth hook 59, in the Y-axis plus direction of the rotation part 57.

The fourth hook 59 is positioned at an end portion of the slide part 55 in the X-axis direction, and is a member which is independent of the slide part 55 and disposed at a position shifted from the first hook 52 in the Y-axis plus direction. In other words, the fourth hook 59 is disposed at the same position in the Y-axis direction as the position of the third hook 54. In addition, the fourth hook 59 protrudes in the Z-axis plus direction similarly to the third hook 54, and has a hook-shaped end portion in the X-axis plus direction. In other words, the fourth hook 59 has a hook-shaped end portion in the direction opposite to the direction in which the third hook 54 is disposed.

The rotation part 57 rotates to the left as shown in (b) of FIG. 7B because the end portion thereof in the Y-axis minus direction is moved in the X-axis plus direction by the notch part 55a of the slide part 55 when the slide part 55 slides in the X-axis plus direction. In this way, the end portion of the rotation part 57 in the Y-axis plus direction slides the notch part 59a of the fourth hook 59 in the X-axis minus direction opposite to the slide direction of the slide part 55. In this way, the charge target device 2 fixed in the hole part 2a by the fourth hook 59 is released.

As described above, by sliding the tab 51 of the latch part 50A in the X-axis plus direction, the first hook 52, the second hook 53, and the third hook 54 move in the X-axis plus direction, and the fourth hook moves in the X-axis minus direction. In this way, it is possible to release the first body part 10 and the second body part 20 fixed by the first hook 52 and the second hook 53, and the charge target device 2 fit in the hole parts 2a and 2b and fixed by the third hook 54 and the fourth hook 59.

In addition, the slide part 55 receives force from the first spring 56 (see a hatched arrow in FIG. 7B) from a position slid by the user with a finger to an initial position (in other words, in the X-axis minus direction). More specifically, the slide part 55 and the protrusion part 14 which extends from the case 11a maintain a distance d1 by application of force by the first spring 56. Furthermore, the fourth hook 59 receives force from the second spring 58 (see the hatched arrow in FIG. 7B) from the rotation part 57 from a position after a slide by the user using a finger to an initial position (in other words, toward the X-axis minus direction). More specifically, the fourth hook 59 and the protrusion part 15 which extends from the case 11a maintain a distance d2 by application of the force from the second spring 58.

In this way, when the user does not add any force onto the slide part 55 using the tab 51, a no-slide state shown in FIG. 7A can be maintained. In other words, when the first body part 10 and the second body part 20 are closed, the closed state of the first body part 10 and the second body part 20 can be maintained. In addition, when the charge target device 2 is held by the third hook 54 and the fourth hook 59, the holding state by the third hook 54 and the fourth hook 59 can be maintained. When the user adds force onto the slide part 55 using the tab 51, as shown in FIG. 7B, the slide part 55 moves in the X-axis plus direction, and thus the distance between the slide part 55 and the protrusion part 14 is reduced to a distance d3 smaller than the distance d1. Furthermore, the fourth hook 59 moves in the X-axis minus direction in conjunction with a movement of the slide part 55, the distance between the fourth hook 59 and the protrusion part 15 is reduced to a distance d4 smaller than the distance d2. As described above, in a state in which the slide part 55 and the fourth hook 59 are slid, the first spring 56 and the second spring 58 add stronger force respectively onto (i) the slide part 55 and the protrusion part 14 and (ii) the fourth hook 59 and the protrusion part 15, in the direction opposite to the sliding direction.

### (Features)

(1)

Since the information terminal device 1a according to Embodiment 2 includes the holding part 40A for holding the charge target device 2 on the case 11a, the charge target device 2 can be integrated into the information terminal device 1a using the holding part 40A. In this way, it is possible to hold the charge target device 2 in the holding part 40A even when the posture of the information terminal device 1a changes while the information terminal device 1a is being carried around and used, and thus to keep charging the charge target device 2.

(2)

In addition, in the information terminal device la according to Embodiment 2, the holding part 40A is a recess part 43 to which the charge target device 2 is fit, and thus the charge target device 2 fits into the recess part 43 at least partly while the charge target device 2 is being charged. For this reason, it is possible to prevent the charge target device 2 from being protruding unnecessarily in a state in which the charge target device 2 is integrated into the information terminal device la. Thus, it is possible to carry around the information terminal device is in a compact form.

(3)

In addition, in the information terminal device 1a according to Embodiment 2, it is possible to release the charge target device 2 fitting into the recess part 43 of the case 11a, in conjunction with a release of the latch part 50A fixing the end portions of the first body part 10 and the second body part 20 in the Y-axis minus direction. In this way, the latch part 50A fixes the first body part 10 and the second body part 20 and also fixes the charge target device 2 and the recess part 43, which contributes reduction in the number of components. In addition, since the latch part 50A maintains the charge target device 2 which is fit in the recess part 43 of the case 11a, it is possible to prevent the charge target device 2 from detaching from the recess part 43 during charging due to shock from outside.

### Variations

Each of the information terminal devices 1 and 1a according to Embodiments 1 and 2 is a so-called lap-top PC including the first body part 10 and the second body part 20 connected via the hinge part 13. However, the present invention is not limited thereto. For example, a so-called tablet terminal including a first body part but does not include a second body part is also possible.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable as information terminal devices capable of easily charging charge target devices in a non-contact manner away from home, and particularly to lap-top PCs, tablet terminals, etc.

1. An information terminal device which is portable and capable of charging a charge target device, the information terminal device comprising:
a first body part including a display panel and a case which covers the display panel; and
a power transmission coil provided at a position on a back surface of the case opposite to the display panel, for supplying power to be charged in the charge target device in a non-contact manner.

2. The information terminal device according to claim 1, further comprising
a holding part for holding the charge target device at a position in the case, the position corresponding to the power transmission coil.

3. The information terminal device according to claim 2,
wherein the holding part is provided in the case, and includes a recess part to which the charge target device is fit.

4. The information terminal device according to claim 3,
wherein the holding part further includes:
a plate member which fits in the recess part; and
connection parts which connect the plate member and the case such that the plate member is movable between a first position and a second position relative to the case, the plate member being at the first position relative to the case when the plate member is fit in the recess part, and at the second position apart from the case by a predetermined distance in a direction opposite to a recess direction of the recess part.

5. The information terminal device according to claim 4,
wherein the power transmission coil is provided in the plate member.

6. The information terminal device according to claim 3,
wherein the power transmission coil is provided at a bottom surface of the recess part.

7. The information terminal device according to claim 4, further comprising:
a second body part including a keyboard which receives an input from a user;
a hinge part which rotatably connects the first body part and the second body part at side end portions thereof; and
a latch part capable of selectively maintaining and releasing, at opposite side end portions thereof, a state in which the first body part and the second body part are closed via the hinge part,
wherein the latch part is further capable of maintaining a state in which the plate member is fit in the recess part, and releases the state in which the plate member is fit in the recess part, in conjunction with the release of the state in which the first body part and the second body part are closed via the hinge part.

8. The information terminal device according to claim 3, further comprising
a second body part including a keyboard for receiving an input from a user;
a hinge part which rotatably connects the first body part and the second body part at side end portions thereof; and
a latch part capable of selectively maintaining and releasing, at opposite side end portions thereof, a state in which the first body part and the second body part are closed via the hinge part,
wherein the latch part is capable of maintaining a state in which the charge target device is fit in the recess part, and releases the state in which the charge target device is fit in the recess part, in conjunction with the release of the state in which the first body part and the second body part are closed via the hinge part.

9. The information terminal device according to claim 4,
wherein the power transmission coil is provided at a bottom surface of the recess part.

10. The information terminal device according to claim 5, further comprising:
a second body part including a keyboard which receives an input from a user;
a hinge part which rotatably connects the first body part and the second body part at side end portions thereof; and
a latch part capable of selectively maintaining and releasing, at opposite side end portions thereof, a state in which the first body part and the second body part are closed via the hinge part,
wherein the latch part is further capable of maintaining a state in which the plate member is fit in the recess part, and releases the state in which the plate member is fit in the recess part, in conjunction with the release of the state in which the first body part and the second body part are closed via the hinge part.

11. The information terminal device according to claim 6, further comprising:
a second body part including a keyboard which receives an input from a user;
a hinge part which rotatably connects the first body part and the second body part at side end portions thereof; and
a latch part capable of selectively maintaining and releasing, at opposite side end portions thereof, a state in which the first body part and the second body part are closed via the hinge part,
wherein the latch part is further capable of maintaining a state in which the plate member is fit in the recess part, and releases the state in which the plate member is fit in the recess part, in conjunction with the release of the state in which the first body part and the second body part are closed via the hinge part.

12. The information terminal device according to claim 9, further comprising:
a second body part including a keyboard which receives an input from a user;
a hinge part which rotatably connects the first body part and the second body part at side end portions thereof; and
a latch part capable of selectively maintaining and releasing, at opposite side end portions thereof, a state in which the first body part and the second body part are closed via the hinge part,
wherein the latch part is further capable of maintaining a state in which the plate member is fit in the recess part, and releases the state in which the plate member is fit in the recess part, in conjunction with the release of the state in which the first body part and the second body part are closed via the hinge part.
